(19) United States
(12) Patent Application Publication
(10) Pub. No.: US 2009/0302708 A1
(43) Pub. Date: Dec. 10, 2009

(54) SHAPE MEMORY ALLOY ACTUATOR

(75) Inventor: Masaya TAKAHASHI, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/481,765

(22) Filed: Jun. 10, 2009

(30) Foreign Application Priority Data
Jun. 10, 2008 (JP) JP 2008-151740

(51) Int. Cl. H02N 10/00

(52) U.S. Cl. 310/306

(57) ABSTRACT

An actuator has a shape memory alloy wire that contracts when heated by electric power supply and expands when cooled, whereby its length changes, a first hollow member through which the shape memory alloy wire is inserted, a movable element having an end mechanically connected to the shape memory alloy wire and movable relative to the first hollow member along a direction along which the length of the shape memory wire changes, an elastic member that is arranged between the movable element and the first hollow member and by which an external force is exerted on the movable element in a direction in which the shape memory alloy wire expands. In addition, an insulation member is joined to the movable element, apart of the insulation member is inserted in the first hollow member in a movable manner, and the shape memory alloy wire is connected to the end of the inserted part. Thus, the shape memory alloy wire is prevented from being in electrical contact with the elastic member.

### CROSS-REFERENCE TO RELATED APPLICATION

The present application is based upon and claims the benefit of priority from the prior Japanese Patent Application No. 2008-151740 filed on Jun. 10, 2008; the entire contents of which are incorporated herein by reference.

### BACKGROUND OF THE INVENTION

1. Field of the Invention

The present invention relates to a shape memory alloy actuator.

2. Description of the Related Art

A shape memory alloy changes its shape with transformation caused by a change in the temperature. Actuators that utilize deformation of the shape memory alloy have characteristics that are advantageous, for example, in reducing the size and weight of the actuators.

For example, in an actuator disclosed in Japanese Patent Application Laid-Open No. 2008-23275, one end of a wire member made of a shape memory alloy (which will be sometimes referred to as an SMA or a shape memory alloy wire hereinafter) is fixed and the other end is a movable. This document discloses a technique in which the movable end is driven by a stress of a bias spring and a contracting force generated by a change in the length of the shape memory alloy wire resulting from a change in the temperature caused by heating the shape memory alloy wire with a electrical power supply thereto.

In an actuator that uses a bias spring and an SMA wire like the above-described prior art, in order to achieve a further reduction in the size of the actuator, in particular a reduction in the diameter of the actuator, it is necessary to make the diameter of the bias spring small. The smaller the diameter of the bias spring is, the more effective the use of a metal bias spring is in order to achieve good spring performance. The shape memory alloy wire serving as a driving source of the actuator is heated by supplying electric power or current thereto. Therefore, when the bias spring is made of a metal, it is desirable that the wire of the shape memory alloy wire is electrically insulated from the bias spring to ensure stable expansion and compression of the spring.

### SUMMARY OF THE INVENTION

The present invention has been made in view of the above described situation and has as an object to provide a shape memory alloy actuator in which the bias spring exhibits stable performance and the shape memory alloy wire is electrically insulated from the bias spring.

To solve the above-described problem and to achieve the above object, according to the present invention, there is provided a shape memory alloy actuator comprising a shape memory alloy wire that contracts when heated by electric power supply and expands when cooled, whereby its length changes, a first hollow member through which the shape memory alloy wire is inserted, a movable element having an end mechanically connected to the shape memory alloy wire and movable relative to the first hollow member along a direction along which the length of the shape memory wire changes, an elastic member that is arranged between the movable element and the first hollow member and by which an external force is exerted on the movable element in a direction in which the shape memory alloy wire expands, an insulation member joined to the movable element, wherein a part of the insulation member is inserted in the first hollow member in a movable manner, and the shape memory alloy wire is connected to the end of the inserted part.

According to a preferred mode of the present invention, it is desirable that the shape memory alloy wire be fixedly attached on an end portion of the insulation member.

According to another preferred mode of the present invention, it is desirable that the insulation member have a hollow structure, and the shape memory alloy wire be inserted in the insulation member.

According to still another preferred mode of the present invention, it is desirable that the actuator further comprise a second hollow member fixed in the interior of the first hollow member, and the shape memory alloy wire be inserted in the second hollow member, and an end of the second hollow member that is not fixed to the first hollow member be fixedly attached to an end of the shape memory alloy wire.

According to still another preferred mode of the present invention, it is desirable that the second hollow member be bendable.

### BRIEF DESCRIPTION OF THE DRAWINGS

FIGS. 1A and 1B schematically show, partly in cross section, the structure of a shape memory alloy actuator according to a first embodiment of the present invention;

FIG. 2 schematically shows, partly in cross section, the structure of a shape memory alloy actuator according to a second embodiment of the present invention;

FIG. 3 schematically shows, partly in cross section, the structure of a shape memory alloy actuator according to a third embodiment of the present invention.

### DETAILED DESCRIPTION OF THE INVENTION

In the following, embodiments of the shape memory alloy actuator according to the present invention will be described in detail with reference to the accompanying drawings. It should be understood that the present invention is not limited to the embodiments.

### First Embodiment

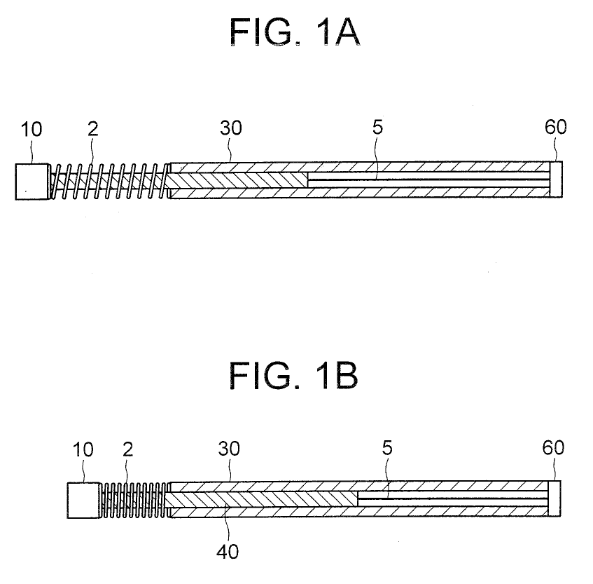

A shape memory alloy actuator according to a first embodiment of the present invention will be described. FIGS. 1A and 1B illustrate the structure of an SMA wire according to the first embodiment partly in cross section. The SMA wire 5 contracts when heated with electric power supply and expands when cooled. The power supply apparatus is not shown in FIG. 1A or 1B.

FIG. 1A shows a cross section of the actuator in the state in which the SMA wire 5 has been expanded by cooling. One end of the SMA wire 5 is fixed to a fixing member 60, which constitutes a solderless terminal. The fixing member 60 is fixed to an insulation cylinder 30 or a first hollow member. The other end of the SMA wire 5 is connected to a cylindrical insulation member 40. The insulation member 40 is connected with a movable element 10.

The insulation member 40 is inserted in the insulation cylinder 30. The insulation member 40 is movable in the interior of the insulation cylinder 30 in the horizontal direction in FIG. 1A and FIG. 1B. The movable element 10 moves with the movement of the insulation member 40. A bias spring 2 is a compression coil spring. Thus, it exerts a stress on the movable element 10 in the leftward direction in FIGS. 1A and 1B.

In FIG. 1A, the SMA wire 5 is in the expanded state. Therefore, a leftward (in FIG. 1A) stress exerted by the bias spring 2 produced a leftward stress in the movable element 10. The movable element 10 is kept stationary at the position determined by the length of the SMA wire 5 and the length of the insulation member 40. A stopper may be provided to mechanically stop the movement of the movable element 10, as will be naturally understood.

FIG. 1B illustrates the state in which the SMA wire 5 has been contracted by heating with electric power supply. When the SMA wire 5 contracts, the contracting force of the SMA wire 5 is stronger than the stress of the bias spring 2. Therefore, the movable element 10 is displaced rightward from the position shown in FIG. 1A.

Thus, the shape memory alloy actuator is adapted to prevent electrical connection between the bias spring 2 and the SMA wire 5. Thus, at the time of heating with electric power supply, power loss due to current flow from the SMA wire 5 to the bias spring 2 can be prevented.

The bias spring 2 is supported by the insulation member 40 that serves as a shaft that passes through the bias spring 2. Thus, repetitive expansion and compression of the bias spring 2 can be performed stably, even if the spring has such a high length-to-diameter ratio that does not allow it to keep its spring shape by itself.

Furthermore, when the position of the movable element 10 is controlled by controlling the length of the SMA wire 5 by feedback based on the resistance of the SMA wire 5, reliable monitoring of the resistance of the SMA wire 5 can be ensured, because the SMA wire 5 is not in electrical contact with the bias spring 2. In addition, it is desirable that the insulation cylinder 30 be rigid in order to increase the stability of the movement of the insulation member 40 in the insulation cylinder 30.

### Second Embodiment

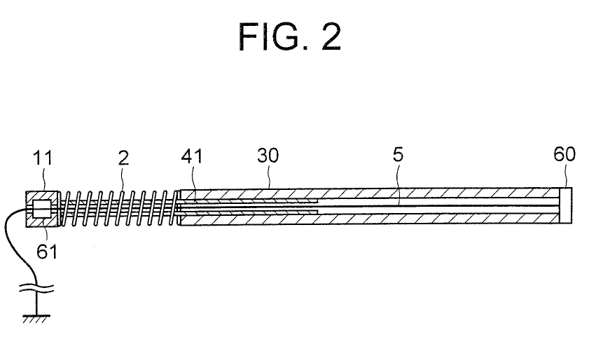

In the following, a second embodiment of the present invention will be described. FIG. 2 illustrates the structure of an SMA actuator according to the second embodiment partly in cross section. The portions same as those in the first embodiment will be denoted by the same reference signs to omit redundant description.

In this embodiment, an SMA wire 5 is inserted through a hollow insulation member 41. The hollow insulation member 41 is joined to a movable element 11. The movable element 11 has an inner passage through which the SMA wire 5 can pass.

A part of the SMA wire 5 is fixed to a fixing member 61, which constitutes a solderless terminal. The fixing member 61 is fixed to the movable element 11 in the interior of the movable element 11. Thus, the SMA wire 5 passes though the hollow insulation member 41 and the movable element 11. Thus, the SMA wire 5 can be arranged to come out from the movable element 11 without being in contact with the bias spring 2. Consequently, electrical connection between the SMA wire 5 and the electric power supply (not shown) for heating can be made simple. Simplification of the electrical connect can also be achieved by connecting a lead wire to the fixing member 61 and arranging this lead wire, instead of the SMA wire 5, to come out from the movable element 11.

### Third Embodiment

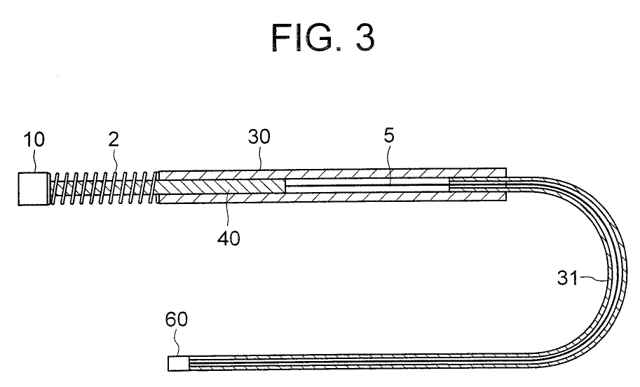

In the following, a third embodiment of the present invention will be described. FIG. 3 illustrates the structure of an SMA actuator according to the third embodiment partly in cross section. The portions same as those in the first embodiment will be denoted by the same reference signs to omit redundant description.

An insulation tube 31 or a second hollow member is fixed to an end of an insulation cylinder 30. An SMA wire 5 is inserted into the insulation tube 31. The SMA wire 5 is fixed at the end of the insulation tube 31 by the fixed end 60.

The amount of expansion and contraction of the SMA wire 5 is proportional to its length. The length of the SMA wire 5 can be made longer by providing the insulation tube 31 having a large axial length. Thus, the possible drive stroke of the movable element 10 can be increased. Furthermore, in the case where the insulation tube 31 can be bent as shown in FIG. 3, it is possible to save space by bending the insulation tube, and the actuator can be built in an apparatus having a bending mechanism.

As described above, the shape memory alloy actuator according to the present invention can be advantageously applied to an actuator having a bias spring.

The present invention can provides a shape memory alloy actuator that is advantageous in that the bias spring can operate stably and the shape memory alloy wire is electrically insulated from the bias spring.

What is claimed is:

1. A shape memory alloy actuator comprising:
a shape memory alloy wire that contracts when heated by electric power supply and expands when cooled, whereby its length changes;
a first hollow member through which the shape memory alloy wire is inserted;
a movable element having an end mechanically connected to the shape memory alloy wire and movable relative to the first hollow member along a direction along which the length of the shape memory wire changes;
an elastic member that is arranged between the movable element and the first hollow member and by which an external force is exerted on the movable element in a direction in which the shape memory alloy wire expands;
an insulation member joined to the movable element, wherein
a part of the insulation member is inserted in the first hollow member in a movable manner, and the shape memory alloy wire is connected to the end of the inserted part.

2. A shape memory alloy actuator according to claim 1, wherein the shape memory alloy wire is fixedly attached on an end portion of the insulation member.

3. A shape memory alloy actuator according to claim 1, wherein the insulation member has a hollow structure, and the shape memory alloy wire is inserted in the insulation member.

4. A shape memory alloy actuator according to any one of claims 1 to 3, further comprising a second hollow member fixed in the interior of the first hollow member, wherein the shape memory alloy wire is inserted in the second hollow member, and an end of the second hollow member that is not fixed to the first hollow member is fixedly attached to an end of the shape memory alloy wire.

5. A shape memory alloy actuator according to claim 4, wherein the second hollow member is bendable.
